(19) United States
(12) Patent Application Publication
(10) Pub. No.: US 2011/0087592 A1
(43) Pub. Date: Apr. 14, 2011

(54) SYSTEMS AND METHODS FOR FACILITATING TRANSACTIONS

(76) Inventors: Larry van der Veen, San Carlos, CA (US); Charles Marshall, Atherton, CA (US); Paul Spaeth, Half Moon Bay, CA (US); Devin Wade, Seattle, WA (US)

(21) Appl. No.: 12/578,225

(22) Filed: Oct. 13, 2009

(51) Int. Cl. G06Q 20/00; G06F 17/00; G06F 15/16

(52) U.S. Cl. 705/44; 235/383; 709/204; 235/375

(57) ABSTRACT

Pursuant to some embodiments, a payment account including multiple subaccounts is provided where each subaccount can be used only for payment for a designated category of products. Pursuant to some embodiments, purchases using the subaccounts can be automatically combined in a single transaction to redeem multiple categories of products, with each subaccount providing funds for the redemption of a single product category. In some embodiments, the payment account may include a subaccount that contains value that is unrestricted and available for general spending or to automatically provide supplementary funds for the redemption of products from subaccounts with product category restrictions. The value contained within each subaccount may be immediately available funds, access to credit provided by an entity who has agreed to extend credit to the account holder for purchasing products in a designated category or a combination of these types of value. Alternatively, in some embodiments, the value may include benefits provided by a health care plan whose redemption is limited to specific categories of products and services as provided by the plan.

### FIELD

The present invention relates to consumer payment accounts and products. In particular, the present invention relates to systems and methods for facilitating transactions involving multiple product categories using a single payment account with one or more subaccounts.

### BACKGROUND

The field of card payment systems includes well-established practices and standards for authorizing, clearing and settling purchases conducted by consumers at merchant locations. These transactions typically involve a single card account used for payment of a single purchase amount in a single purchase event. For example, consumers are commonly issued credit cards which include an account number identifying a credit account associated with the consumer. When the consumer uses the credit card to make a purchase (even if multiple products are purchased) a single transaction (for the total purchase amount) is posted to the consumer's credit account.

In some cases, payments for purchases are divided among different payment tenders, with each payment tender corresponding to a payment instrument issued under a separate account by a single issuer or by separate instruments issued by different issuers. For example, it is not uncommon for a cardholder to pay for a purchase using funds from both a debit and a credit card, or for a cardholder to designate which part of the purchase amount is to be paid for with the credit card and which part of the payment is to be paid for with the debit card. Cardholders may, for example, desire to pay for some categories of items with a debit card which possesses tax advantages for buying approved health care related products and the remaining categories of items with a credit card or cash. In these cases, the choice of how to allocate purchase amounts to various payment instruments and the choice of instruments to be used for payment requires a close interaction between the cardholder and the merchant. For example, the cardholder may need to complete separate payment transactions (using separate payment instruments) for different categories of products.

Current payment systems lack the flexibility and functionality to enable cardholders to acquire and use a single payment account containing multiple subaccounts designated for payment of a specific category of products. More particularly, current systems do not support the processing of a single transaction which includes the redemption of multiple types of products or product categories using multiple subaccount funds with each subaccount restricted for redemption of a particular subset of products in the transaction. An example is a case in which third party payors of health care benefits desire to fund a stored value account but wish to restrict eligible purchases to specific health care products, such as over the counter drugs or medical devices. In instances in which multiple payors each provide value to a beneficiary in the form of funds or access to credit with conditions that restrict the redemption of the funds to specific categories of products, current payment systems are unable to redeem funds from each subaccount in an automated fashion that satisfies the conditions of the value providers.

While payment systems support the limitation of purchase transactions to categories of merchants or industries using Merchant Category Codes and other industry standards, there does not exist the ability to redeem value from payment accounts based upon an identification of the individual product or services being purchased.

### BRIEF DESCRIPTION OF THE DRAWINGS

FIG. 1 is a block diagram representation of a system that may be provided according to some embodiments.

FIG. 2 is a flow chart that illustrates a product data creation method that may be performed according to some embodiments.

FIG. 3 is a flow chart that illustrates a method for issuing a redemption request message that may be performed according to some embodiments.

FIG. 4 is a flow chart that illustrates a method for generating a redemption response message that may be performed according to some embodiments.

FIG. 5 is a flow diagram that illustrates a method for processing a redemption response message that may be performed according to some embodiments.

FIG. 6 is a flow diagram that illustrates a payment authorization request process that may be performed according to some embodiments.

FIG. 7 is a block diagram of an account provider device according to some embodiments.

FIG. 8 is a block diagram of a merchant device according to some embodiments.

FIG. 9 is a tabular representation of a portion of an account database according to some embodiments.

FIG. 10 is a tabular representation of a portion of a product database according to some embodiments.

FIG. 11 is a flow chart that illustrates a method for generating an authorization response message including redemption response data that may be performed according to some embodiments.

### DETAILED DESCRIPTION

To alleviate problems inherent in the prior art, the present invention introduces systems and methods in which a single payment account may be accessed which has multiple subaccounts, each having one or more permitted product categories that may be purchased using funds from the subaccount.

Pursuant to some embodiments, a payment account including multiple subaccounts is provided where each subaccount can be used only for payment for a designated category of products. Pursuant to some embodiments, purchases using the subaccounts can be automatically combined in a single transaction to redeem multiple categories of products, with each subaccount providing funds for the redemption of a single product category. In some embodiments, the payment account may include a subaccount that contains value that is unrestricted and available for general spending or to automatically provide supplementary funds for the redemption of products from subaccounts with product category restrictions. The value contained within each subaccount may be immediately available funds, access to credit provided by an entity who has agreed to extend credit to the account holder for purchasing products in a designated category or a combination of these types of value. Alternatively, in some embodiments, the value may include benefits provided by a health care plan whose redemption is limited to specific categories of products and services as provided by the plan.

Pursuant to some embodiments, transaction processing involving multiple product categories and multiple subaccounts with each subaccount is provided where the processing is restricted to the redemption of products from a particular category. In some embodiments, restricted subaccount values can be automatically combined with unrestricted value in cases where restricted funds are insufficient to redeem a purchase. In some embodiments, the designation of how funds should be combined in a purchase can be made either by the account holder or by the account provider. The processing of transactions pursuant to some embodiments includes an initial categorization of products at a merchant point of sale and an automated adjudication of product category subtotals against account holder subaccounts designated for redemption of individual product categories. Once adjudicated, the purchase transaction is submitted for authorization, clearing and settlement in a manner that is consistent with the processing of standard payment transactions.

Pursuant to some embodiments, the authorization request and redemption request messages are transmitted in a single message from the merchant to the account provider, and the account provider initiates clearing and settlement of an approved portion of the transaction based on the single message received from the merchant.

Pursuant to some embodiments, methods of categorizing products at the point of purchase are provided. Merchants, including product and service providers, access a database which links accounts to product categories eligible for purchase with the account and links product categories to individual products using product codes such as Universal Product Code (UPC) indicators. Using the database, merchants are able to match each product to a product category and also determine if a particular account being presented for payment is linked to a restricted category of products.

With these and other advantages and features of the invention that will become hereinafter apparent, the invention may be more clearly understood by reference to the following detailed description of the invention, the appended claims, and the drawings attached herein.

For the purposes of describing features of embodiments of the present invention, a number of terms are used herein. For example, the term “account access device” is used to refer to a token, card or other device that is associated with a payment account pursuant to the present invention and which is issued to an account holder (such as an insured consumer or business). An account access device may be provided in any of a number of different forms, including as a standard ISO 7816 magnetic stripe card (such as a debit card, credit card, stored value card, prescription card, medical card, or the like) as an RFID chip encapsulated in a card or other device, as a chip or application embodied in a smart phone or PDA, or as a virtual account number so long as the account access device identifies (or allows identification of) an associated account.

As used herein, the term “product” is used to refer to physical products or goods (such as pharmaceuticals, over the counter drugs, medical devices or aids, or the like) as well as services (such as services rendered or to be rendered by a medical professional or the like).

As used herein, the term “category” or “product category” is used to refer to a grouping of products. A grouping may be made based on characteristics of a product (e.g., eyeglasses may be grouped together), and/or based on the tax or reimbursement qualifications of a product (e.g., generic prescription medications may be grouped together). The categorization of products may be modified from time to time, and the term “category” is not meant to imply a fixed or permanent grouping of products. In some embodiments, a category may consist of a single product. As used herein, a wide variety of different product identifiers may be used to identify individual products (and to associate those products with categories). For example, products may be identified by one or more of the following codes or identifiers: a stock keeping unit (SKU) code, a universal product code (UPC), a global trade item number (GTIN), a European Article Number (EAN) code, an International Standard Book Number (ISBN), a Current Procedural Terminology (CPT), an International Classification of Diseases (ICD), an Healthcare Common Procedure Code (HPCP) code, a product serial number, or other coding or identification schemes now known or later developed.

Prior to describing features of the present invention in detail, an illustrative example will first be introduced. This example is purely for illustration of certain features of some embodiments. In the example, a cardholder (John) is issued an account access device (in this example, the device is a magnetic stripe card with a card body embossed with John's name, and a primary account number or “PAN” and with a magnetic stripe storing card data). The access device is issued by a financial institution (“Big Bank”) and is associated with an account held by Big Bank for John. The account has several subaccounts associated with it, including an “unrestricted” subaccount which is a prepaid account, such as a prepaid debit card account (having an available balance of $1,000). The account also has two “restricted” subaccounts, one is restricted to purchases of products categorized as “over the counter drugs”, and another restricted to purchases of products categorized as “prescription drugs”. The first restricted subaccount is linked to a stored value account as a source of value, and John has previously deposited $500 into the stored value account. The second restricted subaccount is linked to an account provided by John's health care plan as a source of value.

In the illustrative example, John will purchase three products at a merchant: a box of stationary, a bottle of prescription sleeping pills, and a bottle of over the counter pain medication.

Pursuant to some embodiments, John is able to use his account access device at participating merchant locations and may purchase products from different categories (and even products not included in any permitted categories) with a single swipe or presentment of his account access device. By presenting an account access device pursuant to the present invention, John is able to purchase different items in a single transaction and have the purchase of those items funded by different sources of value according to their categorization. John's purchases in this illustrative example will be followed throughout the remainder of this disclosure as a means to provide a specific example of some features of the present invention.

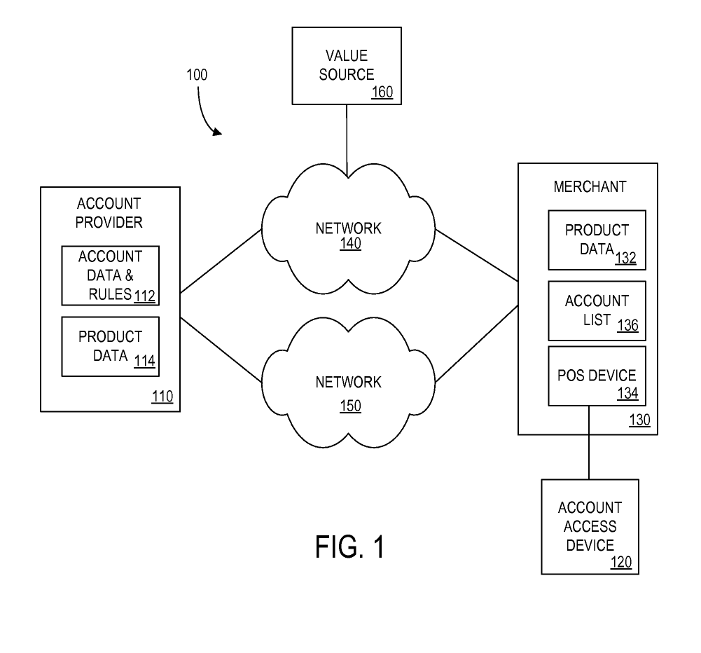

Turning now in detail to the drawings, FIG. 1 is a block diagram representation of a system 100 that may be provided according to some embodiments. The system 100 includes an account provider device 110 in communication with other devices via several communications networks including a first communication network 140 and a second communication network 150. The account provider device 110 may be associated with, for example, a financial institution such as a company or service that issues accounts pursuant to the present invention to consumers (although those skilled in the art will appreciate that the inventive accounts may also be issued to entities such as businesses or groups of individuals).

The account provider device 110 is in communication with a number of devices, including one or more merchant systems 130 and one or more value sources 160. Those skilled in the art will appreciate that a large number of merchant systems 130 and value sources 160 may be in communication with account provider device 110 (and that there may be multiple account provider devices 110). Merchant systems 130 include a number of modules or devices, including one or more point of sale devices 134, a product data store 132, and an account list 136. Value sources 160 may be external (or, in some embodiments, internal) sources of funds or value which are used to transfer or load value into one or more accounts or subaccounts held at the account provider device 110. The value sources 160 may be any of a number of different types or kinds of value sources, including, for example, third party systems, point systems, reward systems, reimbursement accounts, rebates, discounts, loyalty programs, health care benefits, other payment accounts such as stored value, direct deposit, credit, or the like.

As used herein, devices (including the account provider devices 110, the merchant systems 130 and the value sources 160) may communicate, for example, via communication networks 140 and 150 such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cable television network, or an Internet Protocol (IP) network such as the Internet, an intranet or an extranet. Moreover, as used herein, communications include those enabled by wired or wireless technology. In some embodiments, one of the networks 140, 150 is an open loop payment card network such as the BankNet® network operated by MasterCard International Incorporated, or the VisaNet® network operated by Visa International Service Association, or the networks branded as NYCE, STAR, or the like. In some embodiments, one of the networks 140, 150 is a closed loop payment card network such as those operated by American Express or Discover. In some embodiments, one of the networks 140, 150 is a closed loop, private label network.

The account provider device 110 includes a number of components or modules, several of which are shown in FIG. 1 and include an account datastore 112 and a product datastore 114. As will be described in further detail below, the account datastore includes a number of records specifying individual accounts, and their related subaccounts (including any unrestricted and restricted accounts established on behalf of an account holder). The account datastore 112 is created upon issuance of an account to an account holder and may be updated as needed. For example, in the illustrative example above, account provider device 110 is associated with “Big Bank” and the account datastore 112 stores data about John's primary account number as well as the unrestricted subaccount and the two restricted subaccounts. The account datastore 112 also stores data identifying any value sources, and any permitted categories or other rules for using the subaccounts.

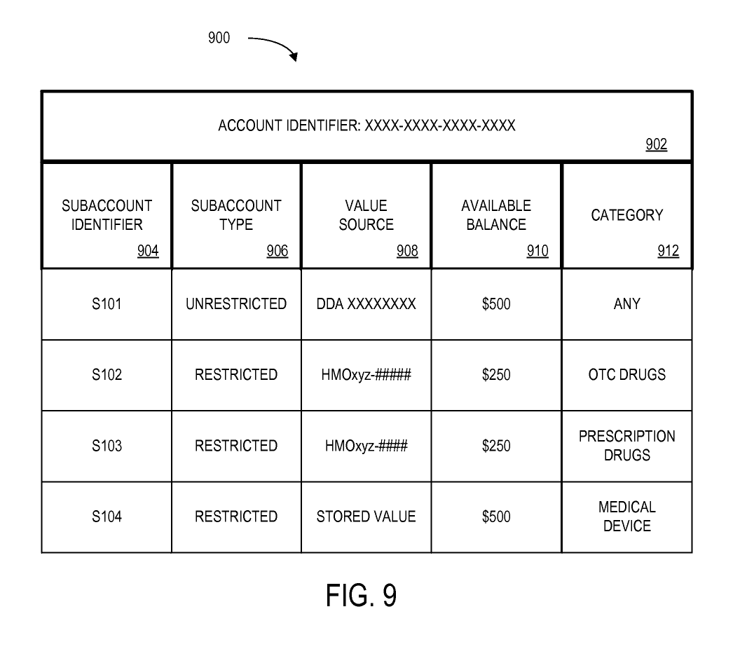

Reference is now made to FIG. 9, which is a portion of a tabular representation of an account datastore 900 that may be stored at the apparatus 110 according to some embodiments of the present invention. In some embodiments, a portion (e.g., such as a list of account numbers) of the account datastore 900 may also be stored at (or accessible to) merchant device 130 as account list 136. The table of FIG. 9 includes entries identifying accounts that have been established (or that may be established or issued) to account holders so that they may utilize account access devices pursuant to the present invention. The table 900 defines fields 902, 904, 906, 908, 910, and 912 for each entry. The fields specify an account identifier 902, and a plurality of: subaccount identifiers 904, subaccount type identifiers 906, value sources 908, available balances 910 and categories 912. The information in the account datastore 900 may be created, for example, upon issuance of a payment account to a cardholder and may be updated as products, funding sources, and other information change during the life of the payment account.

The account identifier 902 may be, for example, an alphanumeric identifier uniquely identifying a particular payment account. In some embodiments, the account identifier is a primary account number (“PAN”) formatted such that a portion of the PAN identifies the account provider (e.g., is formatted as a Bank Identification Number or “BIN”) allowing authorization and redemption request messages to be routed to the account provider for authorization and other processing.

The subaccount identifier 904 may be, for example, an alphanumeric identifier identifying a particular subaccount associated with the account identifier 902. The subaccount type 906 may represent a type of the subaccount identified by subaccount identifier 904 (e.g., in some embodiments, a subaccount may be either a restricted or an unrestricted type of subaccount). The subaccount identifier 904 may be used to conditionally process redemption requests as will be described further below.

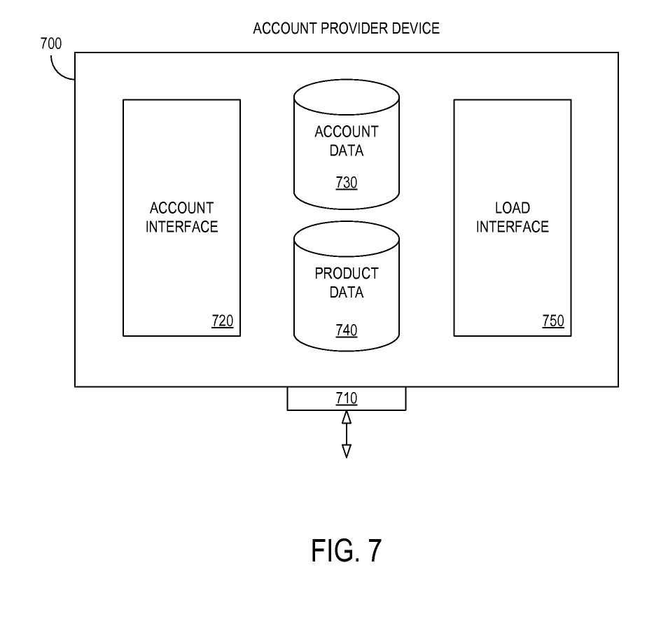

The value source 908 includes information identifying a source of value to be used when funding transactions posted against the account and the subaccount identified by account identifier 902 and subaccount identifier 904. The value source 908 may be a pointer or reference to a value source or it may be a representation of actual value. The value source 908 may have an available balance amount 910. In some embodiments, the identification of a value source for a subaccount may be specified by the account holder or the account provider upon creation of an account. In some embodiments, the value source may be updated or specified after creation of an account. In some embodiments, a load interface (e.g., such as that shown in FIG. 7, discussed below) is used to enable loading of value into subaccounts.

The value loaded into the subaccounts may be in the form of cash, the availability of credit from a third party, points, rewards, reimbursements, rebates, discounts or other forms of value associated with a loyalty program, or benefits as provided under a health care plan. In an exemplary embodiment, the value provided to the subaccounts would be in the form of cash comprising a stored value account which can be used for purchasing a specified set of over the counter drugs. An alternative embodiment may be in the form of a line of credit. Value may be a fixed amount or be variable based upon specified behavior of the account holder or the types of products purchased. For example, in one embodiment the value may include higher discounts for purchases of two or more products in a category.

The value sources identified in the value source field 908 may include the account holder, the account provider or third parties who desire to contribute value to the account, such as business entities, health care plan providers, hospitals, clinics, government entities, individuals, groups, or non-profit organizations. Value sources may provide value to more than one subaccount and contribute different forms of value to each subaccount.

The account datastore 900 also specifies one or more categories 912 which represent categories of products which may be purchased using funds in a given subaccount 904. For example, certain value sources may require that only certain specified categories of products may be purchased using funds from that subaccount and value provider. It is often desirable, for example, for value providers such as health plans to provide benefits to members of the plan but limit those benefits to spending on products and services related to health care or a certain medical condition. In this case, the health plan may designate a category of products which are eligible to be redeemed by the benefits contributed by the plan.

In general, each of the unrestricted subaccounts can hold value that is not limited to spending on any particular product or product category. Unrestricted subaccounts may hold value which is restricted for spending on products which are included in product categories 912 established for that subaccount 904. For example, a subaccount may include value which can only be redeemed for purchases of products included in a category of over-the-counter drugs. This category may specify which Universal Product Codes (“UPC”s) are eligible for redemption of the value contained within the subaccount of that particular account. Products which do not meet the conditions of this category would not be eligible for redemption by this subaccount, but could be redeemed from value included in an unrestricted account. In alternative embodiments of the invention, an account 902 may include only restricted subaccounts without an unrestricted subaccount. In these cases, the account 902 would be limited to spending only on products which correspond to product categories established for each subaccount 904. In one embodiment, the subaccounts 904 may be variable such that the categories 912 may be changed. For example, for a period of time a particular subaccount 904 may be assigned a product category 912 corresponding to over the counter drugs, and subsequently be assigned a product category 912 for prescription drugs.

In some embodiments, the account datastore 900 exist on a computer server managed by account provider 110. The computer server maintains the rules, applications, logic, and interfaces for loading value into the subaccounts, assigning parameters for restricting spending on subaccounts, obtaining current and historical information on account and subaccount activity and balances for purposes of managing the system and providing customer service, adding, managing and deleting account holder information, processing transactions for redeeming value from the subaccounts, creating and issuing tokens or other devices for accessing the account or subaccounts, and calculating, billing and collecting fees and expenses from account holders, merchants and value providers for operating the system. While FIG. 1 shows a single account provider 110, a single merchant 130, a single account access device 120, and a single value provider 160, it should be understood that the system 100 is able to accommodate multiple merchants, multiple accounts and subaccounts, multiple value providers, multiple access devices and multiple account holders.

In some embodiments, some or a portion of the networks allow communication between the value sources 160 and the account provider device 110 to load (or reload) value into payment accounts at the account provider device 110. For example, load or reload transactions may use the Internet, private networks, automated teller networks such as Plus, Cirrus, Star, or NYCE, stored value networks such as GreenDot or ValueLink, or electronic wallet systems such as PayPal. Load or reload transactions may also use open loop payment card networks such as those operated by Visa or, MasterCard, closed loop payment card networks such as those operated by American Express or Discover, or non-branded private label closed loop networks, and may also use electronic funds transfer networks such as the Automated Clearing House or bank wire transfer systems. Further, the networks used to load or reload value may also utilize physical processing systems, such as the use of paper checks and deposits, money orders, or other non-electronic means of transferring value.

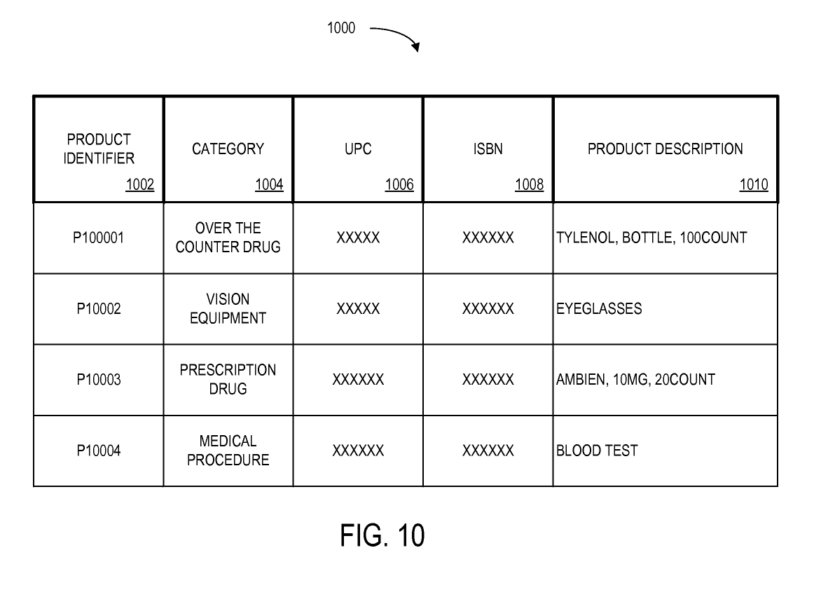

Reference is now made to FIG. 10, which is a portion of a tabular representation of a product datastore 1000 that may be stored at the apparatus 110 according to some embodiments of the present invention. In some embodiments, some or all of the datastore 1000 may also be stored at (or accessible to) merchant device 130 as product data 132. The table of FIG. 10 includes entries identifying individual products that may be purchased and processed pursuant to special rules and subaccounts pursuant to the present invention. The table 1000 defines fields 1002, 1004, 1006, 1008, and 1010 for each entry. The fields specify a product identifier 1002 (used to uniquely identify specific products that may be purchased using the present invention), a category 1004 (uniquely identifying one or more categories or types of products), one or more types of uniquely identifying a product (e.g., such as a UPC code, ISBN code, a bar code, a CPT code, or the like) 1006-1008, and a product description 1010 (which may be, for example, a standardized manufacturer's description of the product and which may be used to describe a purchase in a purchase receipt or statement). The information in the product datastore 1000 may be created, for example, as value providers specify individual products or categories that may be purchased using their source of value, or as merchants 130 and account providers 110 identify additional products in covered categories.

The value sources may specify categories 1004 of products 1002 which condition the spending of value from the subaccount to which they provide value (e.g., as specified in the account database 900). It is often desirable, for example, for value providers such as health plans to provide benefits to members of the plan but limit those benefits to spending on products and services related to health care or a certain medical condition. In this case, the health plan may designate a category of products which are eligible to be redeemed by the benefits contributed by the plan.

Products 1002 may be identified by codes assigned to each product for purposes of providing unique identification, such as UPCs, EANs, GTINs, ISBNs, CPT codes or product serial numbers. For example, a category 1004 may be designated as over the counter drugs and include a set of UPCs which correspond to individual products such as Ephedrin or Tylenol that are eligible for redemption by subaccounts having the category “Over the Counter Drugs” listed as permitted purchases. Each category 1004 may be linked to more than one subaccount. Further, each category 1004 may be comprised of more than one product 1002.

In some embodiments, the table 1000 is maintained by account provider 110 and is distributed to merchants 130 (along with certain account data from table 900). In some embodiments, this distribution may be via a load interface or other connection. For example the data may be distributed to merchants using electronic file distribution techniques based upon standards such as FTP or web services or proprietary communications protocols. In some embodiments, the product data 1000 and selected account data 900 may be distributed using physical media such as CDROMs, DVDs, paper file catalogs, magnetic tapes or magnetic discs. Distribution of the data may occur at least once over a period of time and may occur at regular intervals or as the accounts, product categories or products comprising the account list change or are updated.

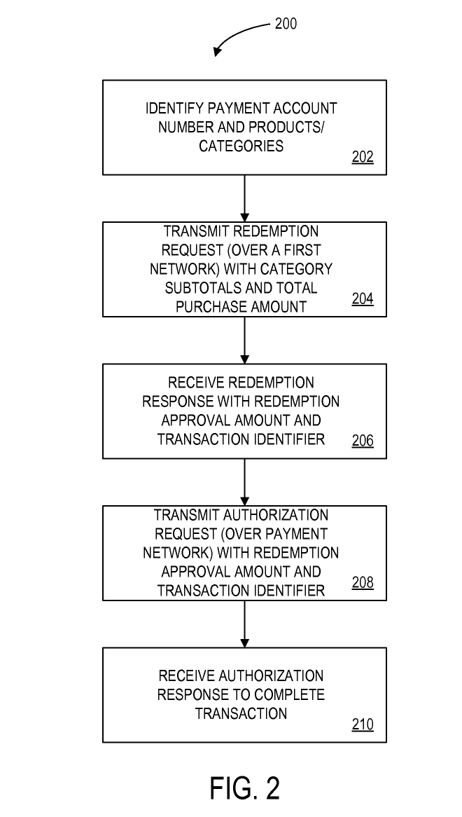

Reference is now made to FIG. 2, which is a flow chart that illustrates a method that may be performed according to some embodiments. The flow charts in FIG. 2 and the other figures described herein do not imply a fixed order to the steps, and embodiments of the present invention can be practiced in any order that is practicable. Moreover, the methods may be performed by any of the devices described herein. The method shown in FIG. 2 may be performed, for example, by the merchant device 130 of FIG. 1, although those skilled in the art will recognize that the elements of FIG. 2 and the other FIGS. described herein may be performed by different parties. For example, each element might be performed by a different party (e.g., by an issuer, an account processor, or any other agent or party). Moreover, any single element might be performed by multiple parties.

Process 200 begins at 202 where a transaction involving a payment account issued pursuant to the present invention is initiated at a merchant location (e.g., such as at a physical point of sale location, an Internet point of purchase or other point of interaction with a merchant). For example, processing may begin when an account holder presents an account access device at a merchant point of sale terminal along with one or more products to purchase. Processing at 202 includes identifying a payment account number (e.g., by reading a magnetic stripe, or otherwise detecting an account number associated with an account access device), and identifying products (and categories of those products) presented for purchase at a merchant location.

Processing continues at 204 where a redemption request message is created and transmitted (over a first network, such as network 140 of FIG. 1) to the account provider 110. The redemption request message includes information identifying the account holder's payment account (e.g., the PAN read from a face or magnetic stripe of the account access device), and one or more categories and category subtotals as well as a total purchase amount.

For example, continuing the illustrative example introduced above, John wishes to purchase three products at the merchant: a box of stationary, a bottle of prescription sleeping pills, and a bottle of over the counter pain medication. As such, processing at 202 (in John's example) may include the merchant swiping John's magnetic stripe payment card to read his PAN (and other account data) and scanning the bar codes of the three products to be purchased. The merchant systems perform other processing which will be described further below (e.g., such as checking John's payment account number and categorizing the products), but for the purposes of FIG. 2, processing includes creating a redemption request message that includes John's payment account information, and category information including a category identifier and a subtotal for each of the product categories, which may be, in this example: $10 for office supplies (for the stationary), $60 for prescription drugs (the sleeping pills) and $10 for over the counter drugs (the pain killers). A total purchase amount of $80 is also transmitted in the redemption request message.

Processing continues at 206 where a redemption response message is received from the account provider. The redemption response message can include a number of items of data for each of the product categories. For example, the redemption response may indicate whether the subaccounts had sufficient value for each of the product categories (e.g., whether each product can be purchased using funds from a specific subaccount) and whether a general spend or unrestricted category must be used. A transaction identifier is also returned in the redemption response for matching of subsequent authorization messages (as will be described further below).

Continuing the illustrative example, the redemption response returned for John's transaction may include the following information: (i) an approval for the prescription drugs (i.e., John's restricted subaccount for that category had sufficient funds), (ii) an approval for the over the counter drugs (i.e., John's restricted subaccount for that category had sufficient funds), and (iii) an approval for the office supplies (i.e., John's account has an unrestricted subaccount allowing him to purchase non-medical related items using the unrestricted subaccount, and that subaccount had sufficient value to purchase the stationary). A total redemption approval amount of $80 is indicated.

Pursuant to some embodiments, the transaction processing is not yet complete—instead, a subsequent authorization request must be transmitted to cause funds to be processed. This occurs at 208 where a standard payment authorization request message is transmitted to the account provider over a second network (such as network 150 of FIG. 1) which may be, for example, a payment card network such as the VisaNet® or BankNet® (or similar) networks as described above. The authorization request includes a transaction amount equal to the total redemption approval amount (returned in 206) as well as the payment account information (identified at 202) and a transaction identifier (returned in 206), merchant identification information as well as other data elements incorporated in standard authorization messages (e.g., such as those compliant with ISO Standard 8583) processed using those networks. The authorization request is transmitted using well-known payment system techniques and an authorization response is received either authorizing or denying the transaction.

In this manner, a payment account holder using a payment account pursuant to the present invention is able to purchase multiple products, from multiple categories, and use funds from multiple value sources in a single transaction. Further, when the account holder receives his or her statement, details of each of the items purchased, along with their relevant categories and source of value may be shown, providing easy record keeping and accounting.

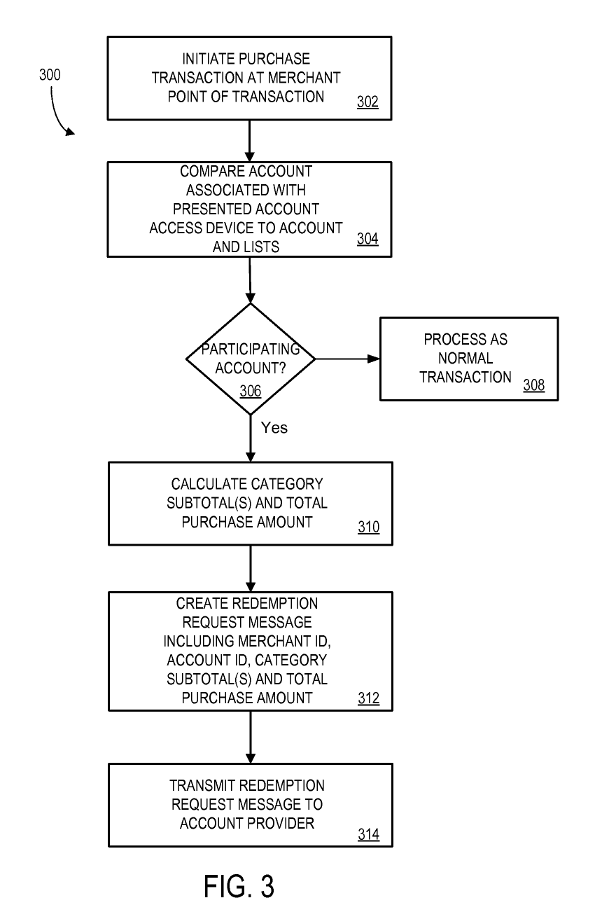

Further details of each of the steps described above will now be detailed by reference to FIGS. 3-6 which provide detailed flows and transaction details. Reference is first made to FIG. 3 which is a flow diagram of a process 300 for issuing a redemption request message pursuant to some embodiments.

Process 300 begins at 302 where a transaction involving a payment account issued pursuant to the present invention is initiated at a merchant location (e.g., such as at a physical point of sale location, an Internet point of purchase or other point of interaction with a merchant). For example, processing may begin when an account holder presents an account access device at a merchant point of sale terminal along with one or more products to purchase.

At 304 the merchant processes scanned, read or key entered information to determine if the payment account received at 302, is included in product category and account lists (132, 136). If the account is not a participating account (or if the products and categories are not ones eligible for processing using the account), processing continues at 308 where the purchase transaction is processed as a normal transaction (e.g., where a single authorization request for the total purchase is submitted using the payment network 150).

In some embodiments, the merchant 130 and the account provider 110 may have an agreement that unless the payment account is included in the account list 136, value from the payment account is not eligible for redemption. If the merchant 130 determines that the payment account is included in the account list 136, processing continues at 310. In some embodiments, processing at 306 is performed by the merchant 130 transmitting the account number to the account provider (e.g., over a network 140) to identify if the account number is in the account list stored at the account provider 110.

Processing continues at 310 where the merchant point of sale system 134 operates to sort the products presented for purchase into one or more categories (e.g., using data read from the product data 132) and then computes a total purchase amount for all products and subtotal amounts for each category. In an alternative embodiment, for accounts included in account list 136, the merchant point of sale system 134 submits each of the product codes such as UPCs from a purchase transaction to account provider 110 (e.g., over network 140) so that the account provider 110 may perform the sorting of products by category and the computation of category specific subtotals and a total purchase amount.

Processing continues at 312 where the merchant point of sale system 134 creates a redemption request message which includes information sufficient to identify the merchant, the merchant's POS location and environment, the access device and the purchase transaction, including category subtotals and the total purchase amount.

Processing continues at 314 where the merchant 130 transmits the redemption request to the account provider 110 over a first network 140. Product information provided to account provider 110 may be in the form of an industry standard such as ISO 8583 or in a proprietary standard.

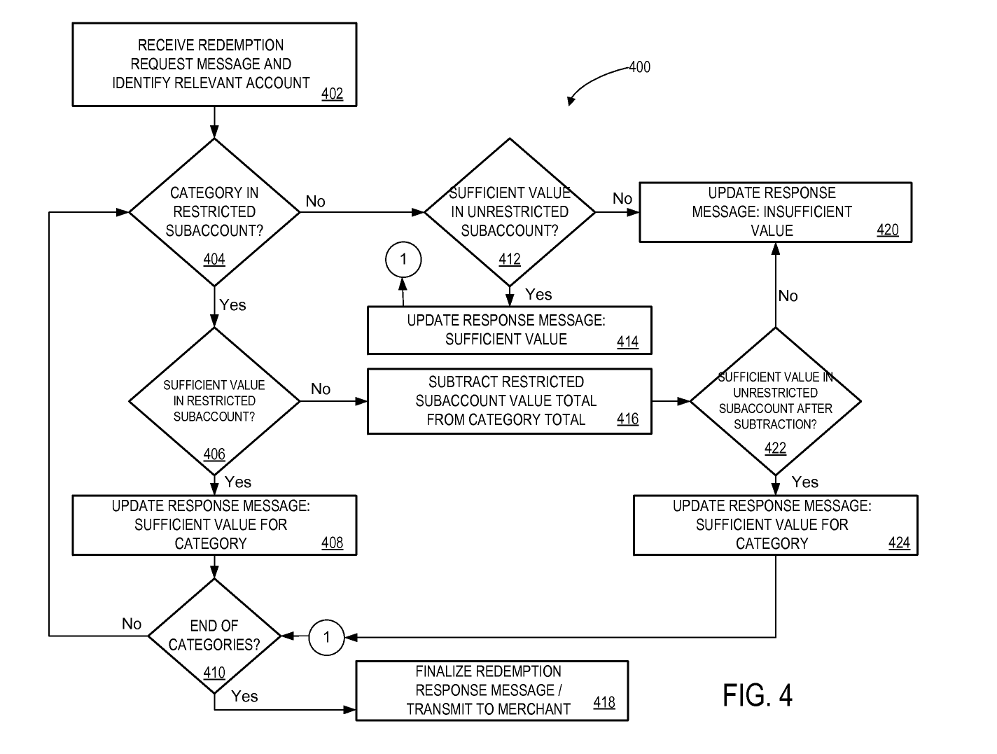

Processing continues at the account provider 110 as shown in FIG. 4 which is a flow chart illustrating a method for generating a redemption response message. The method 400 of FIG. 4 begins at 402 where the account provider 110 receives a redemption request message from the merchant, and identifies the relevant account number from the data in the redemption request message.

Processing continues at 404 where the account provider 110 iteratively compares each category contained in the redemption request message with categories designated in the restricted category subaccounts associated with the account number. This may be performed, for example, by consulting the account datastore 112 (e.g., such as the datastore illustrated in FIG. 9).

In general, the iterative processing proceeds as follows. For a given category of product in the purchase, a first determination is made at 404 if the category is a permitted category of one of the restricted subaccounts. If it is, processing continues at 406 where a determination is made whether there is sufficient value in the restricted subaccount to cover the cost of the products in that category. If so, processing continues at 408 where a redemption response message is updated to indicate that there was sufficient value for the products in that category for redemption.

If there is insufficient value in the restricted subaccount, processing continues at 416 where the value that is available in the restricted subaccount is subtracted from the category total and then a determination is made at 422 if there is sufficient value in any unrestricted subaccount to cover the remaining balance for that category. If so, processing continues at 424 where the response message is updated to indicate that there was sufficient value to cover the cost of products in that category (e.g., redemption of that category was successful).

If processing at 404 indicated that the category was not one that was a permitted category for any of the restricted subaccounts, processing continues at 412 where a determination is made whether there is sufficient value available in any unrestricted subaccount to cover the category subtotal amount. If so, processing continues at 414 where the redemption response message is updated to indicate that redemption of that category is successful. If not, processing continues at 420 where the redemption response message is updated to indicate that redemption of that category was not successful.

This processing repeats until all categories in the redemption request message have been processed and a determination has been made whether redemption in each category is successful or unsuccessful. Upon completion of the iteration, the redemption response message is completed (with redemption responses for each of the categories) and transmitted to the merchant (via the first network, such as network 140). In some embodiments, the account provider 110 stores a record of the redemption response message and assigns it a transaction identifier so that the transaction can easily referred to upon subsequent authorization processing.

In some embodiments, the redemption response data, including the transaction identifier and an indication of sufficient or insufficient funds for each category, are included in a single redemption response message transmitted to the merchant 130. The redemption response message may be in the form of an industry standard such as ISO 8583 or in a proprietary standard.

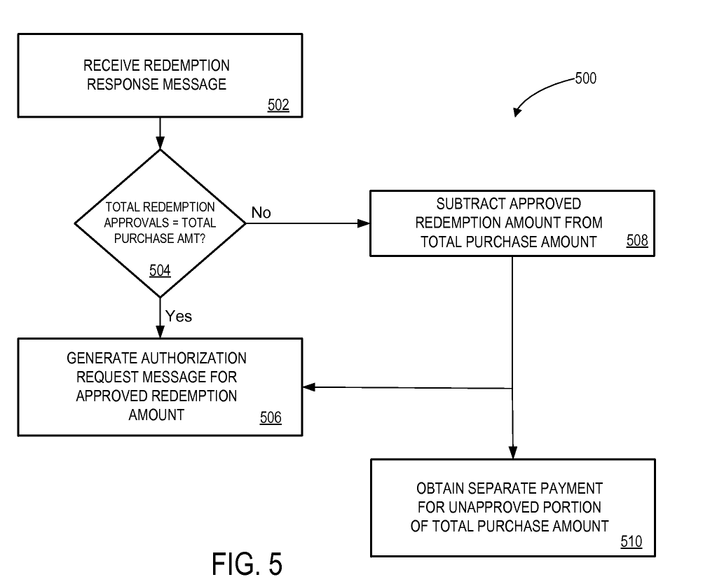

Processing reverts to the merchant location, as shown in FIG. 5, which is a process 500 for processing a redemption response message. Process 500 begins at 502 where the merchant 130 (via the point of sale terminal 136, for example) receives the redemption response message.

At 504, the merchant 130 determines whether the total of the redemption approvals (e.g., the sum of all the category approvals) is equal to the total purchase amount. If so, processing continues at 506 where the merchant constructs a standard payment authorization request message including the total redemption approval amount, the payment account number and other transaction details, and submits the authorization request message to a payment network (e.g., such as network 150 of FIG. 1) for authorization and completion of the transaction. If processing at 504 indicates that the total redemption approvals is less than the total purchase amount, processing continues at 508 where the total redemption approval amount is subtracted from the total purchase amount, and the total redemption approval amount is used in an authorization request message (at 506), while the remaining difference is used in 510. At 510, the account holder is prompted to provide a separate payment for the unapproved portion of the total purchase amount.

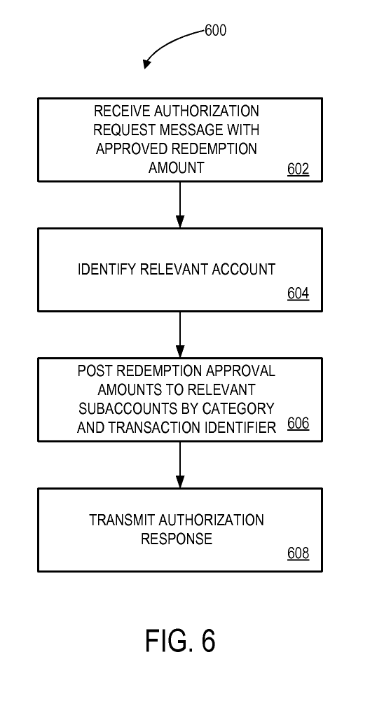

Processing again reverts to the account provider 110 in the process 600 shown in FIG. 6 (which is a process for authorizing a transaction). At 602, the account provider 110 (or an agent of the account provider 110) receives the authorization request from the merchant 130, identifies the relevant payment account (at 604), and completes (at 606) the transaction by posting the redemption approval amounts to the relevant subaccounts by using the category and transaction identifiers. An authorization response is transmitted to the merchant 130 at 608 to finalize transaction processing.

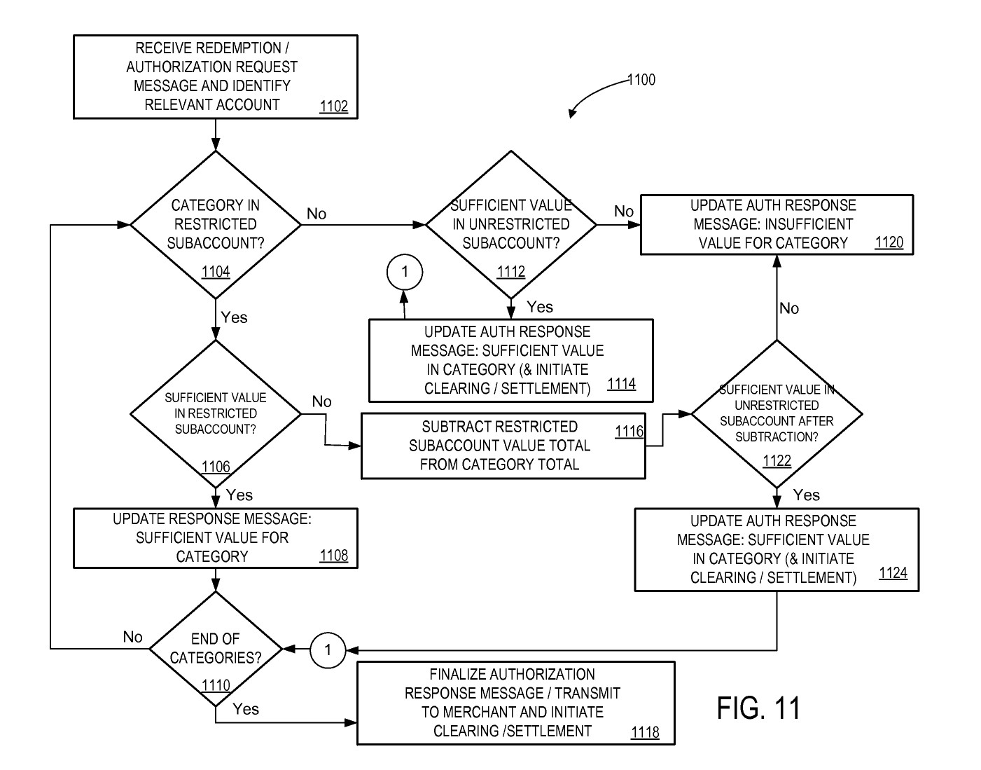

As will be discussed further below in conjunction with FIG. 11, although the use of two networks 140, 150 has been discussed, in some embodiments, the redemption request and authorization processing may be completed using a single transaction, or using a single redemption/authorization request. Further, those skilled in the art, upon reading this disclosure, will recognize that other combinations of messages and networks may also be used.

FIG. 7 is a block diagram of an account provider device 700, such as a device associated with the account provider 110 of FIG. 1, according to some embodiments. In this case, the account provider device 700 includes a communication port 710 to exchange data over networks (such as networks 140, 150) to facilitate communication with, for example, other devices (such as merchant devices 130 and value source devices 160). Note that numerous ports 710 may be provided (to allow for simultaneous communication with a number of other devices) and may be preferably configured with hardware suitable to physically interface with desired external devices and/or network connections. For example, the communication port 710 may comprise an Ethernet connection to a local area network through which the account provider device 700 may receive and transmit information over the Internet and/or over private or proprietary networks.

In addition, the account provider device 700 includes an account interface 720 and a load interface 750 that may be constituted by one or more conventional processors. The interfaces 720, 750 operate to execute processor-executable process steps so as to control the account provider device 700 to provide desired functionality. The account provider device 700 further includes one or more storage devices 730, 740 to store account data and product data. Note that the engines 720, 750 and storage devices 730, 740 may be co-located with, or remote from, the account provider device 700.

The account provider device 700 may operate in accordance with any of the embodiments described herein. By way of example only, FIGS. 4 and 6 are flow charts that illustrates methods that may be performed according to some embodiments.

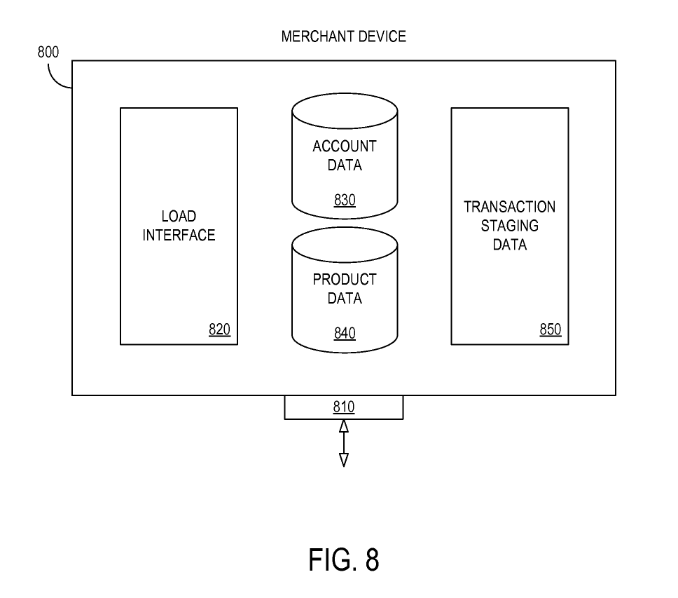

FIG. 8 is a block diagram of a merchant device 800 such as a device associated with the merchant 130 of FIG. 1, according to some embodiments. In this case, the merchant device 800 includes a communication port 810 to exchange data over networks (such as networks 140, 150) to facilitate communication with, for example, other devices (such as account provider device 110). Note that numerous ports 810 may be provided (to allow for simultaneous communication with a number of other devices) and may be preferably configured with hardware suitable to physically interface with desired external devices and/or network connections. For example, the communication port 810 may comprise an Ethernet connection to a local area network through which the account provider device 800 may receive and transmit information over the Internet and/or over private or proprietary networks.

In addition, the merchant device 800 includes a load interface 820 and a transaction staging data area 850 that may be constituted by one or more conventional processors. The interfaces 820, 850 operate to execute processor-executable process steps so as to control the merchant device 800 to provide desired functionality. The merchant device 800 further includes one or more storage devices 830, 840 to store account data and product data. Note that the engines 820, 850 and storage devices 830, 840 may be co-located with, or remote from, the merchant device 800.

The merchant device 800 may operate in accordance with any of the embodiments described herein. By way of example only, FIGS. 2, 3, and 5 are flow charts that illustrate methods that may be performed according to some embodiments.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

For example, in some embodiments, the redemption request and response and the authorization request and response may be combined in a single message and transmitted over a single one of networks 140, 150. Features of such an embodiment will now be described by reference to FIG. 11. The process of FIG. 11 may be performed by an account provider such as the account provider 110 of FIG. 1. The process of FIG. 11 may involve a single network (e.g., such as network 140) providing communication between a plurality of merchant locations and account provider 110.

Processing of FIG. 11 begins at 1102 where the account provider 110 receives a combined redemption and authorization request message from a merchant (such as merchant 130). The combined redemption and authorization request may include substantially the same information as described above in conjunction with FIG. 4. However, in embodiments in which a combined redemption and authorization request message are used, the result of processing at FIG. 11 may be the initiation of clearing and settlement for any categories or other products for which the subaccounts associated with the account have sufficient funds (thereby reducing the need for separate authorization request processing such as that shown in FIG. 5).

For example, for any category for which sufficient funds in a restricted or unrestricted subaccount is available, the account provider 110 may create (or update) an authorization response message indicating that sufficient value exists for the category and, further, initiate clearing and settlement against that subaccount (as shown in blocks 1114, 1108, 1124 and 1118). For any category for which sufficient funds are not available (in either a restricted or an unrestricted sub account), the account provider 110 may create (or update) an authorization response message indicating that the portion of the transaction involving that category or item is not authorized. For any such unauthorized portion of a transaction the merchant 130 may be required to obtain an alternative form of payment from the consumer.

In some embodiments, an account may be associated with a general purpose (or unrestricted) subaccount that may be used to authorize any uncategorized products. For example, in the illustrative example introduced above, if John attempts to purchase a box of stationary, a bottle of prescription sleeping pills and a bottle of over the counter paid medication, process 1100 may cause the prescription drugs to be authorized (and later cleared and settled) against the restricted subaccount restricted for prescription drugs, while the over the counter sleeping pills are authorized (and later cleared and settled) against the restricted subaccount restricted for over the counter medication, and the stationary is authorized (and later cleared and settled) against the unrestricted subaccount. By allowing such purchases to be redeemed (or compared to category and subaccount restrictions) and also authorized, transaction efficiencies can be realized using a single processing network. In some embodiments, the authorization response transmitted to the merchant as a result of process 1100 may include one or more authorization indicators so that the merchant can complete the purchase transaction according to the authorization processing at account provider 110.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for processing a transaction involving at least a first product, the method comprising:
identifying a first category associated with said at least first product;
transmitting, over a first network, a redemption request including information identifying a payment account identifier, a total requested purchase amount, said first category, and a subtotal amount associated with said first category;
receiving a redemption response with a redemption approval amount and a transaction identifier;
transmitting, over a second network, an authorization request including said redemption approval amount and said transaction identifier; and
completing said transaction upon receipt of an authorization response.

2. The method of claim 1, wherein said transaction involves at least a second product, the method further comprising:
identifying a second category associated with said at least second product.

3. The method of claim 2, wherein said redemption request further includes information identifying said second category and a subtotal amount associated with said second category.

4. The method of claim 1, wherein said redemption approval amount is less than said total requested purchase amount, the method further comprising:
obtaining a separate payment amount for an amount equal to the difference between said total requested purchase amount and said redemption approval amount.

5. The method of claim 1, wherein said transmitting said authorization request further includes transmitting said transaction identifier.

6. The method of claim 1, further comprising:
reading a payment account identifier from an account access device; and
prior to said transmitting a redemption request, comparing said payment account identifier to a table of account identifiers to determine that said payment account identifier is eligible to be used in said redemption request.

7. The method of claim 1, wherein said identifying a first category comprises:
identifying said at least first product using an identification code selected from at least one of: a stock keeping unit (SKU) code, a universal product code (UPC), a global trade item number (GTIN), a European Article Number (EAN) code, an International Standard Book Number (ISBN), a Current Procedural Terminology (CPT), an International Classification of Diseases (ICD), a Healthcare Common Procedure (HPCP) Code and a product serial number; and
comparing said identification code to a table of product identification codes to identify said first category.

8. The method of claim 1, wherein said completing said transaction includes initiating clearing and settlement processing to cause said redemption approval amount to be debited from a subaccount associated with said payment account identifier.

9. A method for processing a transaction involving at least a first product, the method comprising:
receiving, over a first network, a redemption request message including information identifying a payment account identifier, a merchant, a total purchase amount, at least a first category, and at least a first category subtotal amount;
identifying a payment account file structure associated with said payment account identifier, said payment account file structure including data identifying at least a first restricted subaccount, at least a first permitted category associated with said first restricted subaccount, and an available balance of said first restricted subaccount;
comparing said at least a first category with said at least first permitted category and said available balance of said first restricted subaccount;
transmitting, over said first network, a redemption response message including a transaction identifier, and a total redemption approval amount;
subsequently receiving, over a second network, an authorization request message including information identifying said payment account identifier, said transaction identifier, and a requested authorization amount; and
comparing said information from said authorization request message to said data in said payment account file structure to complete said transaction.

10. The method of claim 9, wherein said transaction involves at least a second product associated with at least a second category, said redemption request message further including information identifying said at least second category, and at least a second category subtotal amount where the total purchase amount is equal to said first category subtotal amount and said second category subtotal amount.

11. The method of claim 10, said payment account file structure further including data identifying at least a first unrestricted subaccount and an available balance of said at least first unrestricted subaccount.

12. The method of claim 11, further comprising:
comparing said at least second category with said at least first permitted category and said available balance of said first restricted subaccount.

13. A method for processing a transaction involving at least a first product, the method comprising:
receiving, from a merchant, an authorization request message including information identifying a payment account identifier, a merchant identifier, a total purchase amount, at least a first category, and at least a first category subtotal amount;
identifying a payment account file structure associated with said payment account identifier, said payment account file structure including data identifying at least a first restricted subaccount, at least a first permitted category associated with said first restricted subaccount, and an available balance of said first restricted subaccount;
comparing said at least a first category with said at least first permitted category and said available balance of said first restricted subaccount;
creating an authorization response message, said authorization response message including information identifying a total redemption approval amount and a transaction identifier;
transmitting said authorization response message to said merchant; and
initiating a clearing and settlement process for said total redemption approval amount.

14. An account provider device, comprising:
a communication device to receive request messages from a plurality of merchant devices, each request message including data identifying a payment account, a total purchase amount, a plurality of product categories, and a category subtotal for each of said product categories;
a processor coupled to the communication device; and
a storage device in communication with said processor and storing instructions adapted to be executed by said processor to:
identify a payment account file structure associated with said payment account;
for each of said product categories, identify if the category is a permitted category of at least one restricted subaccount associated with said payment account and if the at least one restricted subaccount has an available balance greater than said category subtotal;
for each of said product categories for which the category is at least one of (i) not a permitted category and (ii) has an available balance less than said category subtotal, identify if an unrestricted subaccount has an available balance greater than said category subtotal; and
generate a response message including a transaction identifier and a total approved redemption amount.

15. The device of claim 14, wherein said request message is at least one of a redemption request message and an authorization request message and said response message is at least one of a redemption response message and an authorization response message.

16. The device of claim 15, wherein said request message is a redemption request message received over a first network, the communication device further configured to receive an authorization message over a second network, the storage device further storing instructions adapted to be executed by said processor to:
receive an authorization request message, said authorization request message including said total approved redemption amount; and
generate an authorization response message based on a comparison of said total approved redemption amount and balance information associated with said account.

17. The device of claim 15, wherein said request message is an authorization request message received over a first network, the storage device further storing instructions adapted to be executed by said processor to:
initiate clearing and settlement of said total approved redemption amount.

18. The device of claim 17, wherein said clearing and settlement of said total approved redemption amount includes debiting said total approved redemption amount
from at least a first subaccount associated with said payment account.
